(19) United States
(12) Patent Application Publication
(10) Pub. No.: US 2008/0090216 A1
(43) Pub. Date: Apr. 17, 2008

(54) Baby schedule tracker and storage device

(76) Inventor: Mary A. Clair, Hesperia, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/653,410

(22) Filed: Jan. 16, 2007

Related U.S. Application Data
(63) Continuation-in-part of application No. 11/528,007, filed on Sep. 28, 2006.

(51) Int. Cl. G09B 19/00

(52) U.S. Cl. 434/238

(57) ABSTRACT

A baby schedule tracking and storage device is disclosed. The device is self contained device having a display and a plurality of selectable buttons that each signifying a particular event. When the event occurs, the corresponding is depressed and the event along with the time and date is stored. The data can then be downloaded to a computing device to compile the events and provide numerical and or graphical information regarding the various events. The device further includes additional functionality that allows entry of finite information such as quantity, breast being used, volume and or diet consumed and expelled. Modification of the entered data allows for a user to identify the attitude of the baby when they awake as well as the type diaper discharge. The buttons or housing is made from a material that glows in the dark making locating the device and the associated buttons easier.

### CROSS REFERENCE TO RELATED APPLICATION

This application is a continuation-in-part of applicant's co-pending application Ser. No. 11/528,007 filed Sep. 28, 2006 the entire contents of which is hereby expressly incorporated by reference herein.

### DESCRIPTION

1. Field of the Invention

This invention relates to a baby schedule tracker. More particularly, the present device is a self contained device having a plurality of selectable buttons that each signifying a particular event. When the event occurs, the corresponding button is depressed and the event along with the time and date is stored. The data is then downloaded to a computing device that provides numerical and or graphical information regarding the various events. The device may further have additional features that allow entry of finite information such as quantity, volume, attitude and or diet consumed and expelled.

2. Background of the Invention

Most parents and care givers of babies want to monitor the schedule, development and growth of their baby. A number of books are available for logging this information. Parents and care givers often find that in the rush to take care of the need of the baby, that they are unable to enter the information in a written log. This information includes data such as when the baby wakes, sleeps, eats and requires changing. Collection of the data provides one problem and the collation of the data to determine patterns, trends and a schedule provides another problem. The data must first be grouped, sorted and then plotted or summed to provide valuable feedback. In addition to paper books and logs where people enter data, a number of patents have been filed and or issued to try and collect this data for simple manipulation. Exemplary examples of inventions that try to collect this data are provided below.

U.S. Pat. No. 3,796,208 issued Mar. 12, 1974 to John Anthony Bloice and U.S. Pat. No. 4,619,270 issued Oct. 28, 1986 to Frederick J. Margolis et al. disclose a baby monitor that physically attaches to a baby to detect movement of the baby. The movement is monitored and logged. While these patents monitor some of the movement schedule of a baby they do not monitor the feeding, wake, sleep and changing schedule. The monitor is intended for use in a hospital and only used when the baby is in a crib. The monitor is not a hand held device where depressing a single button will log the data.

U.S. Pat. No. 3,547,106 issued Dec. 15, 1970 to William J. Bornmann and U.S. Pat. No. 3,439,358 issued to T. J. Salmons on Apr. 15, 1969 disclose a monitor for flat type surfaces. The flat surfaces include a number of sensors that detect location and or movement of a person or animal on the surface. While these patents disclose monitoring movement parameters from a subject on the sensor area, information such as food consumed, actual wake time, sleep time, and diaper changes cannot be recorded using the products disclosed in these patents.

U.S. published application number U.S. 2004/0177101 from Carl Underwood that published on Sep. 9, 2004 discloses an electronic infant information recorder. This application discloses a hand held device where data is manually entered. The disclosed information is basically an electronic record book. The information is not transferable to a PC for further compilation of the data, and entry of information for even the waking time of a baby must be manually entered.

What is needed is a simple baby schedule tracking device where the operator can press a single button to log various baby information such as wake time, sleep time, feedings, and diaper changes. The stored data is then transferable, using a standard computer interface connection, into a PC for additional data conversion, collation and computations. The proposed baby schedule tracker and storage device satisfies these requirements.

### BRIEF SUMMARY OF THE INVENTION

It is an object of the baby schedule tracker to provide the device as a self contained unit having buttons associated with specific baby functions such as waking, sleeping, feeding and changing. These functions are entered by pressing a button having an image associated with the function. The buttons are shaped, embossed or otherwise marked to have an icon, pictograph or similar marking that appears like the selected function. The depression of the button stores into memory the function, time and date when the button is depressed. Subsequent button presses are stored into memory.

It is an object of the baby schedule tracker to provide a modifier to the special function that was selected. While the specific function button stores that function into memory, the modifier allows for minor adjustment of the button, for example altering the time, food being fed to the child or feeding quantity. In the storing of feeding time the feeding quantity is entered, and the entered quantity becomes the default quantity for subsequent selections of the feeding button. The data is openable with a common word processing or spreadsheet program where the data is collated, graphed or otherwise altered for easier interpretation. The modifications for a diaper change can include the consistency and or color of the fecal matter or if it was for a urine only change. In the case of modifying the waking state of the baby from fussiness to playful. A mother could also use the modifier to identify which breast was being used to feed the child.

It is another object baby schedule tracker to allow for connection of the device to a computer utilizing a common computer interface connection. Where the user connects the device and the data is automatically transferred, or the user transfers the data by selecting a transfer option.

It is another object baby schedule tracker to provide a display that is numerical or graphical for visual confirmation of the information that was stored. The display shows time and or date information along with the events that are being or are stored in the device.

It is another object baby schedule tracker to provide the shape of the device in the form of a colorful bug, insect, star, doll, animal, flower, plant toy or character that appears to belong in the room of a child.

It is another object baby schedule tracker to optionally include a speaker or similar sounding device that audibly announces the depressed button and may also provide soothing rhythmic sounds to help sooth the baby allowing them to more easily fall asleep.

It is another object baby schedule tracker to further include a solar charging function to provide power to the device to eliminate the need for battery replacement. The device may further include an on and off switch to turn the unit off to save battery power when not desired. The device may also include a sleep mode where it turns itself off and on to conserve battery power.

It is another object baby schedule tracker to include a tether, strap, band or similar device that allows the device to be hung or strapped on a hook, wrist or other similar object.

It is another object of the baby schedule tracker to make some or all of the parts out of a material that glows in the dark to make locating the device and or the buttons easier.

It is still another object baby schedule tracker to provide the device with a microphone that allows the device to automatically store the wake and sleep events. In addition the microphone allows the device to be used as a baby monitor. The microphone may include sound level detection means to only transmit sound in the room when it exceeds a threshold to allow it to conserve battery power. A motion sensor may also be incorporated to detect and log motion of a child into the memory of the baby schedule tracker.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a first front view of one preferred cosmetic embodiment of the baby schedule tracker.

FIG. 2 shows a second front view of one preferred cosmetic embodiment of the baby schedule tracker.

FIG. 3 shows a block diagram of the schedule storage and download functions

FIG. 4 shows computer screen showing compiled data.

### DETAILED DESCRIPTION

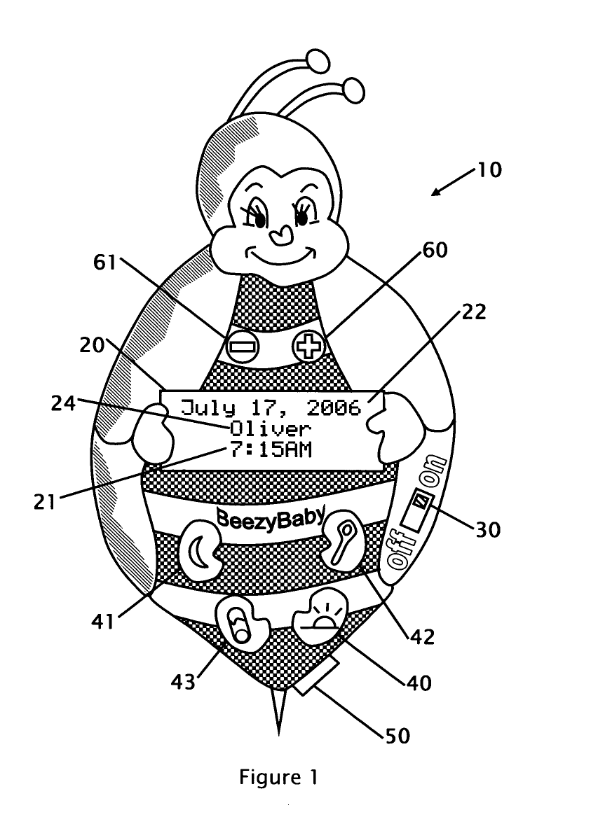

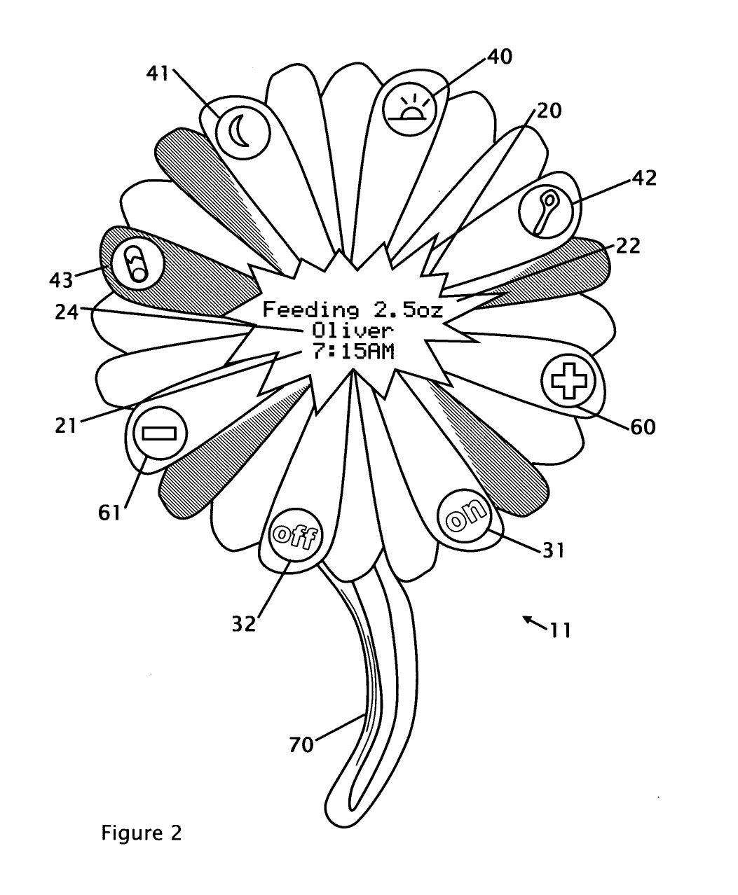

Referring to FIGS. 1 and 2 showing two embodiments of the baby monitor scheduling device called BeezyBaby. In FIG. 1 the embodiment of the baby schedule tracking device 10 is configured to have the appearance of a bee while FIG. 2 shows the embodiment as a flower 11. The shape of the device is not a critical function of the device, but it is contemplated that the overall shape be a generic type that would fit in a baby's room and have the appearance as a product that does not appear out of place. In both these configurations, a display 20 is present to provide visual feedback for the buttons that are press as well as indicting that the product is on and is functioning. The display 20 shows the time 21, date 22 and the name of the child 24. The display includes the ability to enter the birth date of the child and show the age of the child in days, weeks, months or years. While the device is shown and described as being dedicated for storage of information on only one child it is contemplated that the device can operate to store a number of babies. The ability to store and track data for multiple babies makes the device useful at a hospital, daycare, or home with multiple babies of the same or different birthdates and names. The name of the child is useful in a situation such as a day care or nursery where multiple babies are present and monitor schedule devices will appear similar without some method of associating a specific monitor with a specific baby. In FIG. 2 the feeding button has been pressed and the feeding amount 23 is shown on display 20. In this embodiment, the display is shown as a black and white character display, but color and or graphical displays are contemplated.

An on and off switch 30 is provided to turn the unit off for extended periods of time in FIG. 1. FIG. 2 shown uses buttons 31 and 32 as the on and off buttons respectively. In the preferred embodiment the apparatus is battery powered to remain self-contained and able to be transported with the baby. It is also contemplated that the apparatus be powered from an AC outlet or charging base. The charging can take place from solar cells located on the housing, from a charging base, or when the device is connected to a computer where charging takes place through the USB 50 or serial or parallel interface connection.

The apparatus includes a series of buttons 40-43 to signify a specific event. In the case of the bee configuration 10, called a BeezyBaby, the buttons 40-43 are shown as feet, and in the flower configuration 11, the buttons 40-43 are located in the pedals. Identification on or near the buttons identify each of the buttons with a specific function. In the configuration shown, identification of function of each button is shown in a pictograph or icon, but text may additionally or substitutionally be used. One button 40 is configured for a wake button. Button 41 is configured for a sleep button. Button 42 is configured for feeding, while button 43 is configured for diaper change. In another contemplated feature, the depression of a button will audibly announce the function of the button that was pressed. The device may require a second depression of the same button to verify that the correct button was depressed. After the button for diaper change is selected the user could then modify the selection to provide additional information regarding the type of change. These modifiers can include but not be limited to wet diaper, dry diaper, diarrhea, solid, color, smell, firm or other similar modifiers that would better define the discharge.

One of the novel functions of this apparatus is the ability to press a single button to enter the information. As an example, when a parent or care giver hears the baby wake, they simply press the wake button, and the time, and date are stored into memory along with the waking event. The single button is depressed prior to picking up the child, or because of the simplicity, the single button can be depressed with the baby in the parents arms. After the button for an awake event is selected the user could then modify the selection to provide additional information regarding the attitude of the child while when they awoke. These modifiers can include but not be limited to happy, playful, sad, cranky, restful, fussy, tired, wet, dry or other similar modifiers that would better define the child's attitude.

In another contemplated embodiment the device uses one or more sensors to detect motion or sound to autonomously store the events into memory.

In another contemplated embodiment, the device includes a speaker or other sound transducer that creates rhythmic sounds that help to induce sleep in the child. It is contemplate that the rhythmic sound is the beating of heart to lull the child to sleep more quickly.

In another contemplated embodiment, the device buttons and or other parts of the device are made of material that glows in the dark to make it easier to locate when there is limited or no light in the room.

In still another contemplated embodiment, the device includes a microphone that transmits sounds within the room to another location. This microphone may further include sound filtering to only transmit sounds above a certain threshold to minimize power used to transmit the signal.

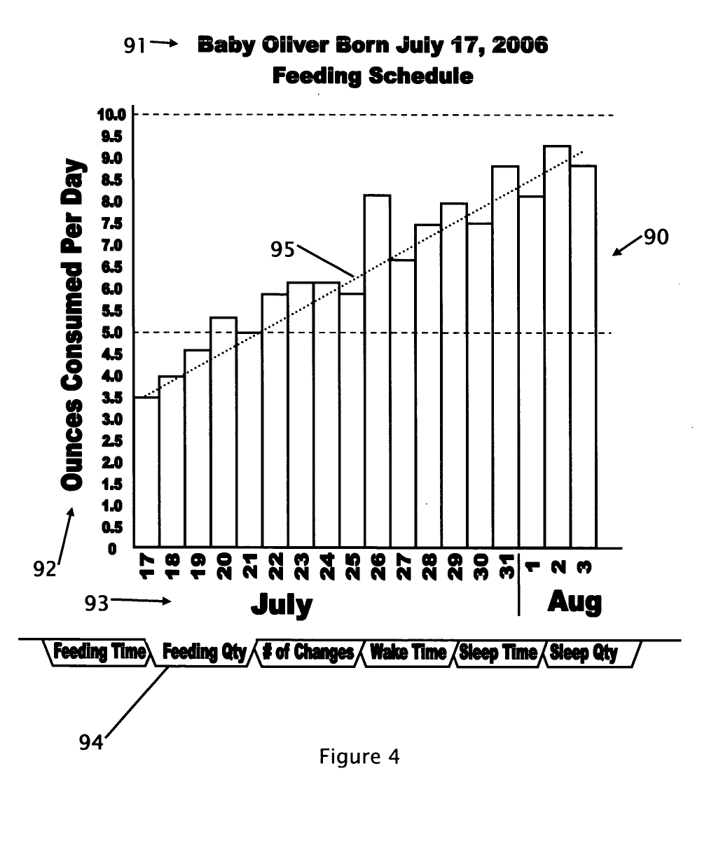

The small transportable configuration allows the apparatus to be placed in a diaper bag, or purse for transportation. It is further contemplated that the apparatus be configured with a strap, string, tether or loop 70 that allows it to be strung, or hung from a door wall or wrist. An extendable stand allows the device to be placed upright on a table, desk or nightstand such that the display is visible. In the examples shown and described the display is shown as a black and white numerical or text display. While this display is shown for simplicity, it is further contemplated that the display can be fabricated as a color display and or with a graphical display to show the information pictorially before it is sent to a computer. The connection to the computer is with a conventional serial or parallel interface using port 50. It is desirable for the device to automatically transfer the data once connection is established with a computer. The data is transferred to a computer where it can be viewed with a word processing program or a spreadsheet program. One example is shown and further described in FIG. 4.

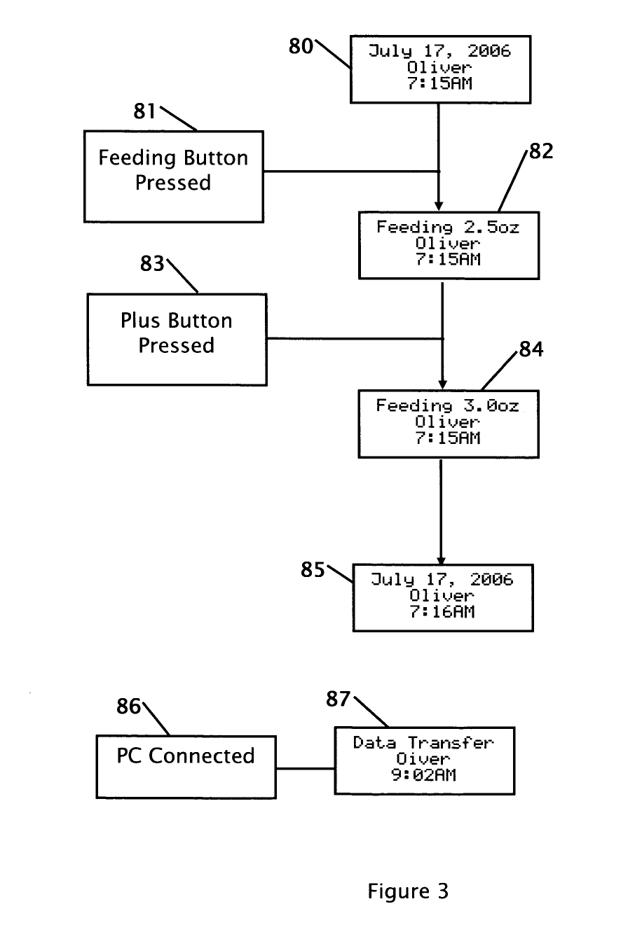

Modifier or adjustment buttons 60 and 61 allow for adjustment or tweaking of the data. An example of this for feeding is when the feeding button is pressed the user can back set or forward set the time of the feeding to account for preparation or to account for a prior event. In another example for feeding, when the feeding button is pressed, the previous quantity is displayed, and the user can adjust this feeding quantity up or down. The adjustment becomes the new default feeding amount for the next time the feeding button is pressed. A similar example is found when the wake button is pressed, the user can adjust the wake time forward or backward to account for variations between the current time and when the user believes the baby will or did actually wakeup. FIG. 3 shows a simplified block diagram shown adjustment of the data. Another contemplated modifier for the feeding button is for a breast feeding mother to identify which breast was being used to feed the child as well as the duration of time the child nursed because volume measurements could not be determined. It is further contemplated that the modifier or adjustment button(s) and allow for entry of the type of food being fed to the child is selectable. The types of food can include but not be limited to carrot, cereal, oatmeal, peaches, peas, prunes and sweet potatoes.

In another contemplated embodiment the device includes the ability to enter notes or other data. This data is entered by selecting characters from the display to build words or include preset words or word strings such as currently used in text messaging in cellular phones.

FIG. 3 shows a block diagram of the schedule storage and download functions. In the default or normal display mode 80 the time and date is shown on the display. This display allows the unit to be used as a clock, and to verify that the unit is correctly operating. In the example shown the feeding button is pressed 81. This button is identified as button 42 in FIGS. 1 and 2. When the button is pressed, the display changes as shown in block 82 to identify that the feeding is logged into memory at the time the button was pressed. The previously entered feeding quantity is loaded from memory and displayed, shown here as 2.5 oz. The user can alter the feeding quantity by pressing the plus (item 60 in FIG. 1 or 2) or the minus (item 61 in FIGS. 1 and 2) buttons. In this figure the plus button is pressed as shown in block 83. The feeding quantity increases to 3.0 oz as shown in block 84. If the user presses the feeding a second time they can alter the time when the feeding took place. After a period of no activity the screen will return to the default screen 85.

When the user connects the device to a computer the device transfers the data from the device to the computer for further analysis. The data can either transfer automatically when connection takes place 86 or when prompted by the device or the computer. When data is being transferred the screen shows that a connection is present and data is being transferred 87. One contemplated type of computer display is shown and described with FIG. 4.

FIG. 4 shows computer screen showing compiled data. This screen is similar to a spreadsheet screen where multiple tabs exist along the bottom of the screen. In this figure the tab for Feeding Quantity 94 has been selected. The top of the screen shows the name of the baby 91 along with the birth date and the title for the graph (Feeding Schedule). The date appears along the X or horizontal axis showing both the month and the date when the reading was collected 93. The Y or vertical axis shows the quantity of formula that was consumed each day in Ounces 92. Each days consumption is shown as a bar 90 in the graph. A linear trend line 95 shows the smoothed change of the data 95. The user can select various other tabs to obtain different information regarding the data that was collected. The information can be printed, emailed, stored, transferred or given to a doctor for review. The different types of data that can be shown includes but is not limited to feeding time, feeding quantity, number of diaper changes, times when diapers are changed, wake time, sleep time and sleep quantity. It is further contemplated that when a file designated to the baby is opened an image or picture of the associated baby opens as a default image.

Thus, specific embodiments of a baby schedule tracker and storage device have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A baby schedule tracking device comprising:
a self contained electronic monitor having a plurality of buttons associated with a babies schedule where the depression of a button stores the associated button function, time, and date into memory;
the selection of buttons further allows for modification or supplementation of said button function, and
a connecting means to connect the device to a computer where the information stored in memory is transferred.

2. The baby schedule tracking device of claim 1 wherein said plurality of buttons includes at least one of sleep, wake, changing, and feeding.

3. The baby schedule tracking device of claim 1 wherein said modification or supplementation allows for alteration of a default stored data.

4. The baby schedule tracking device of claim 3 wherein said modification or supplementation allows for adjustment of the stored time for the associated button function.

5. The baby schedule tracking device of claim 2 that further includes an altering button that allows for adjustment of the feeding quantity, duration or breast being used.

6. The baby schedule tracking device of claim 1 wherein depression of said button associated with feeding stores said quantity of feeding from a previously entered feeding amount into memory.

7. The baby schedule tracking device of claim 1 wherein said device is in the shape of a bug, plant, animal, flower, doll, star, fish, reptile or cartoon character.

8. The baby schedule tracking device of claim 1 wherein said device includes a sound making means to audibly announce said button being depressed.

9. The baby schedule tracking device of claim 3 wherein said modification or supplementation includes information regarding diaper discharge selected from a group consisting of at least one of wet, dry, soft, hard, smelly, color or firmness.

10. The baby schedule tracking device of claim 1 wherein said device further includes an on and off switch or sleep mode capability to reduce power consumption without compromising functionality.

11. The baby schedule tracking device of claim 1 wherein said information that is transferred is in a format that allows said information to be opened using a common spreadsheet and or word processing program for analysis, viewing and printing.

12. The baby schedule tracking device of claim 1 that further includes a tether, strap or band to hang or attach the device.

13. The baby schedule tracking device of claim 1 wherein said buttons associated with functions are color coded, embossed or marked with pictograph or symbols to identify their function.

14. The baby schedule tracking device of claim 1 that further includes a display means for displaying numerical and or graphical representation of the current and or stored data in memory.

15. The baby schedule tracking device of claim 1 that further includes an audible function to provide reproduced rhythmic sounds.

16. The baby schedule tracking device of claim 1 wherein said device further includes a baby monitor for hearing and transmitting sounds.

17. The baby schedule tracking device of claim 17 wherein said device can selectively transmit sounds that are above a preset level to extend battery life of the device.

18. The baby schedule tracking device of claim 1 wherein said device includes a microphone to automatically store sleep times, wake times, and the attitude of the baby when they awake in memory.

19. The baby schedule tracking device of claim 1 wherein said device further includes a motion sensor to detect and record motion around an area of the device.

20. The baby schedule tracking device of claim 1 wherein at least a portion of said device glows in the dark.
